(19) United States
(12) Patent Application Publication
(10) Pub. No.: US 2011/0298389 A1
(43) Pub. Date: Dec. 8, 2011

(54) DISCHARGE LAMP LIGHTING APPARATUS AND DISCHARGE LAMP LIGHTING METHOD

(75) Inventor: Kensuke Nagauchi, Osaka (JP)

(73) Assignee: Panasonic Corporation, Osaka (JP)

(21) Appl. No.: 13/155,389

(22) Filed: Jun. 8, 2011

(30) Foreign Application Priority Data
Jun. 8, 2010 (JP) 2010-130711

(51) Int. Cl. H05B 41/30

(52) U.S. Cl. 315/287

(57) ABSTRACT

A discharge lamp lighting apparatus of the present invention comprises: a power supply section for supplying a discharge lamp voltage prescribed in accordance with the characteristic of the discharge lamp; an inverter for inversely converting the discharge lamp voltage supplied by the power supply section into an AC voltage to be applied to the discharge lamp; and a control section for controlling the discharge lamp voltage in the power supply section and a drive frequency in the inverter, based on the AC voltage applied to the discharge lamp and an AC current flowing in the discharge lamp. The control section controls the discharge lamp voltage in the power supply section and the drive frequency in the inverter such that the AC current flowing in the discharge lamp becomes a square wave having a high-frequency block that is a high-frequency interval, and a low-frequency block that is a low-frequency interval, and that the square wave has spikes so as to make the current value (absolute value) of the AC current as it is just before the polarity of the AC current inverts larger than the current value (absolute value) as it is just after the polarity inverts.

### BACKGROUND OF THE INVENTION

1. Field of the Invention

The present invention relates to discharge lamp lighting apparatuses and discharge lamp lighting methods for lighting discharge lamps, and more particularly relates to a discharge lamp lighting apparatus and a discharge lamp lighting method for controlling AC drive current supplied to a discharge lamp.

2. Description of the Background Art

Conventionally, projection-type image display apparatuses (hereinafter, referred to as projectors) stopped at being used in educational institutions such as schools and in conference rooms and the like of businesses, as well as at being used in a portion of the support sector, but in recent years have come into general, widespread use.

While projectors have come into general, widespread use as just noted, the frequency and the length of time of use are increasing in educational institutions such as schools, and conference rooms and the like of companies.

In addition, as the frequency and the length of time of using projectors are increasing, users having a poor knowledge of projectors have many opportunities to use projectors. It is important to allow such users to use projectors at ease for a long period, that is, for example, it is required that projectors are free from maintenance to the extent possible.

In projectors, discharge lamps such as high-voltage mercury lamps are used for image projection. Therefore, in consideration of the above respect, it is important to increase the life of the discharge lamps which are designed on the assumption that the discharge lamps are to be replaced, among the components of projectors. Although discharge lamps are designed on the assumption that the discharge lamps are to be replaced, the life of discharge lamps is short and it is undeniable that the users will have a negative image if the users need to replace discharge lamps frequently.

Methods for increasing the life of discharge lamps include optimization of the types and the ratio of halides and the like enclosed inside the discharge lamps, and technical improvement in bulbs and electrode configurations. However, in such conventional methods, the life of discharge lamps is about 3,000 hours in general when a maintenance ratio to the initial illuminance (hereinafter, referred to as an illuminance maintenance ratio) as a valid use performance is set at more than 50%. On the other hand, the lives of components of projectors other than discharge lamps are several ten thousand hours. Therefore, it can hardly be said that the life of discharge lamps is sufficiently long.

In addition, various conventional techniques have been disclosed as methods for realizing increase of the life of discharge lamps. For example, Japanese Laid-Open Patent Publication No. 2009-110681 discloses a technique of controlling an AC current supplied to a high-voltage discharge lamp. In addition, Japanese National Phase PCT Laid-Open Patent Publication No. H10-501919 discloses a technique of instantaneously increasing discharge lamp drive current for driving a discharge lamp. In addition, Japanese Laid-Open Patent Publication No. 2007-280734 discloses a technique of making the frequency of a discharge lamp drive current for driving a discharge lamp periodically alternate between a high-frequency and a low-frequency.

However, even if such various conventional methods for realizing increase of the life of discharge lamps are used, it can hardly be said that the life of discharge lamps is increased to a sufficiently long period.

### SUMMARY OF THE INVENTION

Therefore, the present invention has been made to solve the above problems. An object of the present invention is to provide a discharge lamp lighting apparatus and a discharge lamp lighting method for increasing the life of discharge lamps to a sufficiently long period.

In order to achieve the above object, a discharge lamp lighting apparatus for lighting a discharge lamp, according to the present invention comprises: a power supply section for supplying a discharge lamp voltage prescribed in accordance with characteristics of the discharge lamp; an inverter for inversely converting the discharge lamp voltage supplied by the power supply section into an AC voltage to be applied to the discharge lamp; and a control section for controlling the discharge lamp voltage in the power supply section and a drive frequency in the inverter, based on the AC voltage applied to the discharge lamp and an AC current flowing in the discharge lamp. The control section controls the discharge lamp voltage in the power supply section and the drive frequency in the inverter in such a way that the AC current flowing in the discharge lamp becomes a square wave having a high-frequency block that is a high-frequency interval, and a low-frequency block that is a low-frequency interval, and that the square wave has spikes so as to make the current value (absolute value) of the AC current as it is just before the polarity of the AC current inverts larger than the current value (absolute value) as it is just after the polarity inverts.

Preferably, the control section may make the effective current in the high-frequency block and the effective current in the low-frequency block equal to each other.

Alternatively, preferably, the control section may adjust the current value of the AC current in the high-frequency block and/or the current value of the AC current in the low-frequency block.

Alternatively, preferably, the control section may adjust the number of the spikes of the square wave.

Alternatively, preferably, the control section may adjust the current value (absolute value) at the spikes and/or the shapes of the spikes in accordance with characteristics and the state of the discharge lamp.

Alternatively, preferably, the control section may adjust at least the frequency and the number of pulses of the AC current in the high-frequency block and/or at least the frequency and the number of pulses of the AC current in the low-frequency block in accordance with characteristics and the state of the discharge lamp.

Alternatively, preferably, the control section may make the AC current have the spikes in either the high-frequency block or the low-frequency block.

In addition, in order to achieve the above object, a discharge lamp lighting method executed by a discharge lamp lighting apparatus for lighting a discharge lamp, according to the present invention comprises: a power supply step of supplying a discharge lamp voltage prescribed in accordance with characteristics of the discharge lamp; an inverse conversion step of inversely converting the discharge lamp voltage supplied in the power supply step into an AC voltage to be applied to the discharge lamp; and a control step of controlling the discharge lamp voltage supplied in the power supply step and a drive frequency in the inverse conversion step, based on the AC voltage applied to the discharge lamp and an AC current flowing in the discharge lamp. The control step controls the discharge lamp voltage supplied in the power supply step and the drive frequency in the inverse conversion step such that the AC current flowing in the discharge lamp becomes a square wave having a high-frequency block that is a high-frequency interval, and a low-frequency block that is a low-frequency interval, and that the square wave has spikes so as to make the current value (absolute value) of the AC current as it is just before the polarity of the AC current inverts larger than the current value (absolute value) as it is just after the polarity inverts.

In addition, processings performed by the components of the discharge lamp lighting apparatus of the present invention described above may be understood as a discharge lamp lighting method including a series of processing steps. The method may be provided in a form of program for causing a computer to execute the series of processing steps. The program may be introduced into a computer, with a computer-readable storage medium having stored therein the program.

The discharge lamp lighting apparatus and the discharge lamp lighting method according to the present invention described above can increase the life of discharge lamps to a sufficiently long period.

As a result, since the life of discharge lamps used in projectors are increased, users do not need to replace the discharge lamps frequently, and can use projectors for a long period and at ease. In other words, the reliability to users can be improved.

The present invention is useful for a discharge lamp lighting apparatus or a projection-type image apparatus using high-voltage mercury lamps or the like as their discharge lamps, for example.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit block diagram showing the configuration of a discharge lamp lighting apparatus 100 according to an embodiment of the present invention;

FIG. 2 is a function block diagram showing the internal configuration of a control section 130 of the discharge lamp lighting apparatus 100 according to the embodiment of the present invention;

FIG. 3 is a diagram showing an AC current (1) supplied to a discharge lamp 200;

FIG. 4 is a diagram showing an AC current (2) supplied to the discharge lamp 200;

FIG. 5 is a diagram showing a specific example of the case where the effective current in a high-frequency block and the effective current in a low-frequency block are made equal to each other; and

FIG. 6 is a diagram showing a transition of a conventional illuminance maintenance ratio, and a transition of an illuminance maintenance ratio according to the present invention.

### DESCRIPTION OF THE PREFERRED EMBODIMENTS

Hereinafter, an embodiment of the present invention will be described with reference to the drawings.

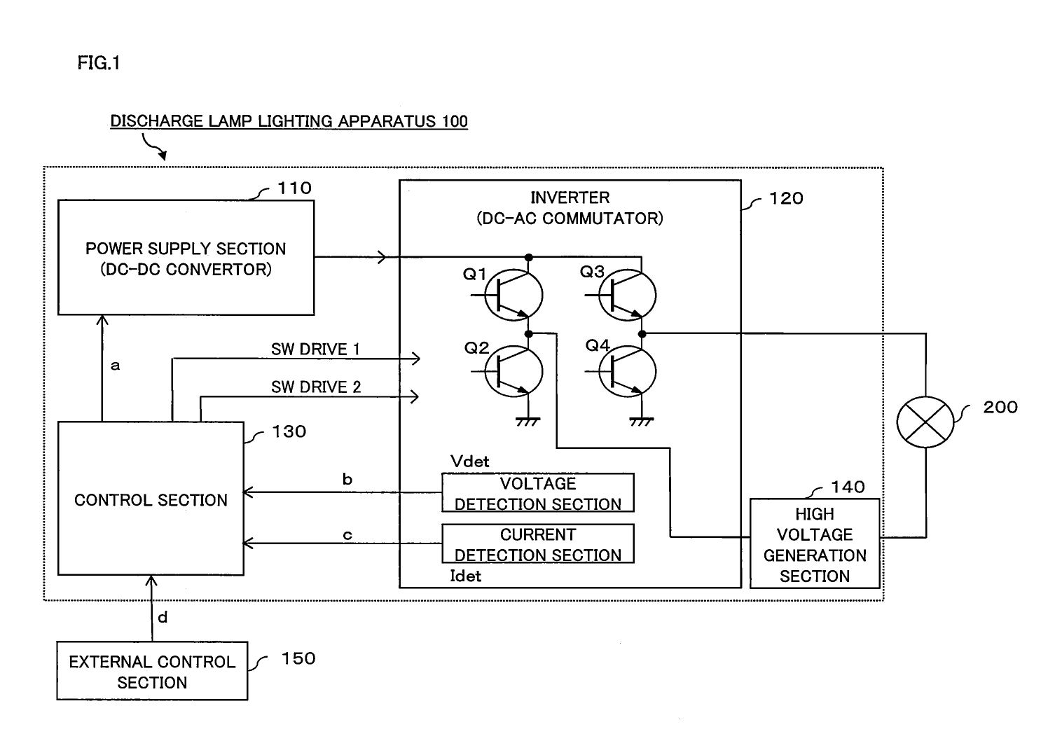

FIG. 1 is a circuit block diagram showing the configuration of a discharge lamp lighting apparatus 100 according to the present embodiment of the present invention. As shown in FIG. 1, the discharge lamp lighting apparatus 100 includes a power supply section (DC-DC convertor) 110, an inverter (DC-AC commutator) 120, and a control section 130. The discharge lamp lighting apparatus 100 applies an AC voltage to a discharge lamp 200 by using the inverter 120 which is of a full-bridge circuit type and includes four switching devices, thereby applying an AC current. As a result, the discharge lamp 200 is lit up.

The power supply section 110 generates a discharge lamp voltage that is prescribed in accordance with characteristics of the discharge lamp 200, and supplies a desired discharge lamp power. For example, the power supply section 110 steps down an input voltage (about 380 V) to generate the discharge lamp voltage needed for lighting the discharge lamp 200, and supplies the discharge lamp voltage to the discharge lamp 200 via the inverter 120. It is noted that the power supply section 110 controls the discharge lamp voltage, based on a power supply section drive signal a outputted from the control section 130.

The inverter 120 includes switch devices Q1 to Q4. The inverter 120 performs ON/OFF control for the switch devices Q1 to Q4, thereby inversely converting the discharge lamp voltage generated by the power supply section 110 into an AC voltage.

In addition, the inverter 120 includes a voltage detection section Vdet and a current detection section Idet. The voltage value detected by the voltage detection section Vdet, and the current value detected by the current detection section Idet are fed back, as a discharge lamp voltage signal b and a discharge lamp current signal c, respectively, to the control section 130.

The control section 130 performs ON/OFF control for the switch devices Q1 to Q4 of the inverter 120, based on the discharge lamp voltage signal b and the discharge lamp current signal c which have been fed back, by using an SW drive 1 and an SW drive 2 which are square wave signals whose phases have been controlled relative to each other. In addition, the control section 130 generates a power supply section drive signal a for controlling the discharge lamp voltage generated by the power supply section 110, based on the discharge lamp voltage signal b and the discharge lamp current signal c which have been fed back.

The AC voltage generated in this way by the inverter 120 is applied to the discharge lamp 200, whereby an AC current flows in the discharge lamp 200 and the discharge lamp 200 is lit up.

It is noted that the discharge lamp lighting apparatus 100 may further include a high voltage generation section 140. The high voltage generation section 140 generates a high voltage when lighting of the discharge lamp 200 is started. After the discharge lamp 200 is lit up, the high voltage generation section 140 does not operate and becomes almost short-circuited. When lighting of the discharge lamp 200 is begun, electric discharge is caused between the electrodes of the discharge lamp 200, whereby lighting of the discharge lamp 200 is realized.

In addition, the discharge lamp lighting apparatus 100 may further include an external control section 150. The external control section 150 manages the use conditions of the discharge lamp lighting apparatus 100 and/or the discharge lamp 200, and controls the control section 130 by using an external control signal d, thereby causing the control section 130 to perform control of the discharge lamp voltage and ON/OFF control for the switch devices Q1 to Q4 in accordance with the use-conditions.

It is noted that the use conditions of the discharge lamp lighting apparatus 100 and/or the discharge lamp 200 include, for example, a use temperature and a use cumulative time period. In addition, the external control section 150 may determine the use conditions in accordance with information such as a normal mode that lights the discharge lamp 200 at a predetermined power, an energy saving mode that lights the discharge lamp 200 at less than the predetermined power, and settings by a user's operation.

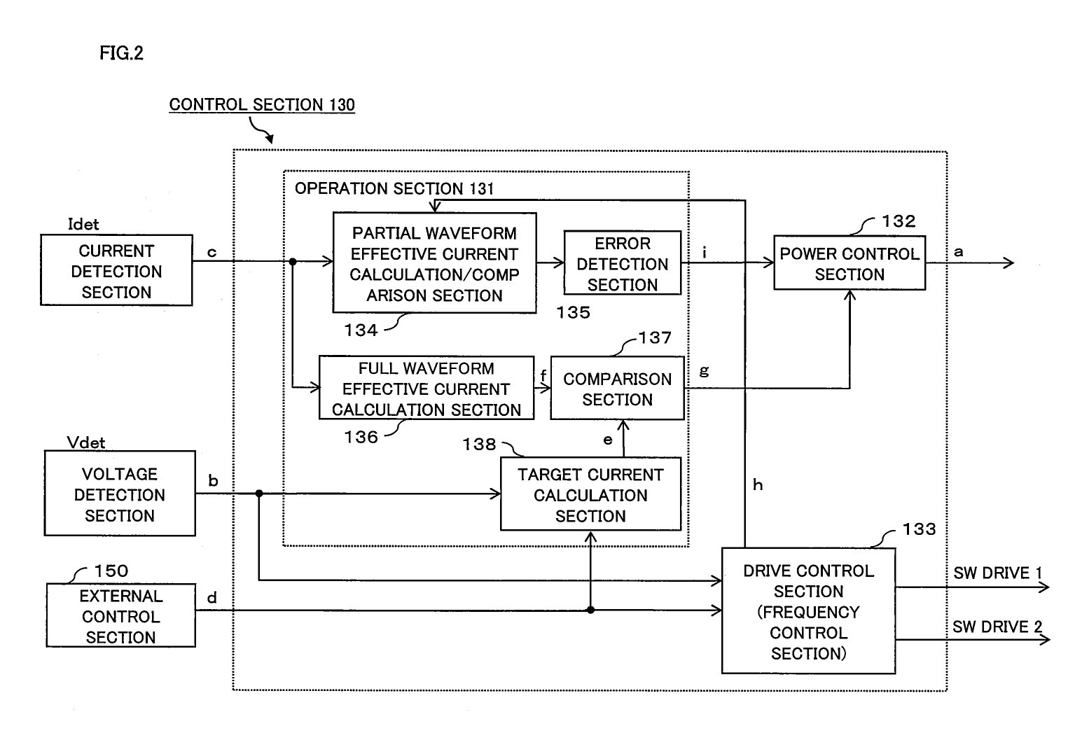

Here, the details of the control section 130 of the discharge lamp lighting apparatus 100 will be described. FIG. 2 is a function block diagram showing the internal configuration of the control section 130 of the discharge lamp lighting apparatus 100 according to the present embodiment of the present invention. As shown in FIG. 2, the control section 130 includes an operation section 131, a power control section 132, and a drive control section (frequency control section) 133.

The discharge lamp current signal c from the current detection section Idet, the discharge lamp voltage signal b from the voltage detection section Vdet, and the external control signal d from the external control section 150 are inputted to the operation section 131. The operation section 131 performs a predetermined operation described later, based on the discharge lamp current signal c, the discharge lamp voltage signal b, and the external control signal d, thereby outputting a power control signal g to the power control section 132.

Based on the power control signal g from the operation section 131, the power control section 132 outputs, to the power supply section 110, the power supply section drive signal a for controlling the discharge lamp voltage generated by the power supply section 110.

Based on the discharge lamp voltage signal b from the voltage detection section Vdet and the external control signal d from the external control section 150, the drive control section 133 outputs the SW drive 1 and the SW drive 2 for performing ON/OFF control for the switch devices Q1 to Q4 of the inverter 120.

Next, internal processing performed by the operation section 131 will be specifically described. The operation section 131 includes a partial waveform effective current calculation/comparison section 134, an error detection section 135, an full waveform effective current calculation section 136, a comparison section 137, and a target current calculation section 138.

The discharge lamp voltage signal b which indicates the voltage value detected by the voltage detection section Vdet is inputted to the target current calculation section 138. The target current calculation section 138 calculates a target discharge lamp current value e, based on the discharge lamp voltage signal b, and a desired discharge lamp power needed for lighting the discharge lamp 200.

The discharge lamp current signal c which indicates the current value detected by the current detection section Idet is inputted to the full waveform effective current calculation section 136. The full waveform effective current calculation section 136 calculates an effective current value of a full waveform, based on the discharge lamp current signal c, and outputs a full waveform effective current signal f.

The comparison section 137 constantly compares the target discharge lamp current value e from the target current calculation section 138, with the full waveform effective current signal f from the full waveform effective current calculation section 136, and controls the power control section 132 by using the power control signal g such that the target discharge lamp current value e and the full waveform effective current signal f are equal to each other.

The power control section 132 outputs the power supply section drive signal a, based on the power control signal g from the comparison section 137, thereby controlling the power supply section 110 such that a desired target power is supplied to the discharge lamp 200. In addition, the drive control section 133 outputs the SW drive 1 and the SW drive 2, based on the control signal d from the external control section 150 and the discharge lamp voltage signal b from the voltage detection section Vdet, thereby controlling the inverter 120 so as to obtain a desired drive frequency.

The discharge lamp current signal c fed back from the current detection section Idet has a high frequency or a low frequency, and does not constantly have an identical frequency. In addition, a current flowing in the discharge lamp 200 is controlled so as to be increased (made to have a spike) for a moment just before the polarity inverts, in order to keep the shapes of the electrodes of the discharge lamp 200. As a result, the effective current is different between frequency blocks (intervals) of high-frequency and low frequency. Here, the control of increasing the current for a moment just before the polarity inverts is realized by increasing, in comparison with power outputted by the power supply section 110 just after the polarity has inverted, power outputted by the power supply section 110 just before the polarity inverts next, based on the power supply section drive signal a.

Here, if the effective current is different between frequency blocks (intervals) of high-frequency and low frequency, effective power supplied to the discharge lamp 200 also varies. Therefore, luminance variation (flicker) occurs in the discharge lamp 200, resulting in an uncomfortable phenomenon that is unpleasant to the user's eyes.

In order to prevent this phenomenon, the drive control section 133 feeds back frequency information h for controlling the inverter 120 to the partial waveform effective current calculation/comparison section 134, based on the discharge lamp voltage signal b which indicates the voltage value detected by the voltage detection section Vdet, and the control signal d from the external control section 150.

The partial waveform effective current calculation/comparison section 134 calculates and compares effective currents in the respective frequency blocks of high-frequency and low-frequency, based on the frequency information h from the drive control section 133, and the discharge lamp current signal c from the current detection section Idet.

Based on the result of the calculation and comparison by the partial waveform effective current calculation/comparison section 134, the error detection section 135 detects an error between the effective currents in the respective frequency blocks of high-frequency and low-frequency, and outputs a power error correction signal i for each frequency block, to the power control section 132.

The power control section 132 adjusts the power supply section drive signal a for controlling the discharge lamp voltage generated by the power supply section 110, based on the power error correction signal i from the error detection section 135.

In this way, the current value of the AC current supplied to the discharge lamp 200 is controlled such that the effective currents in the respective frequency blocks (intervals) of high-frequency and low-frequency are made equal to each other, whereby luminance variation (flicker) of the discharge lamp 200 is prevented.

It is noted that the drive control section 133 may further use the external control signal d from the external control section 150, to adjust the SW drive 1, SW drive 2, and the frequency information h.

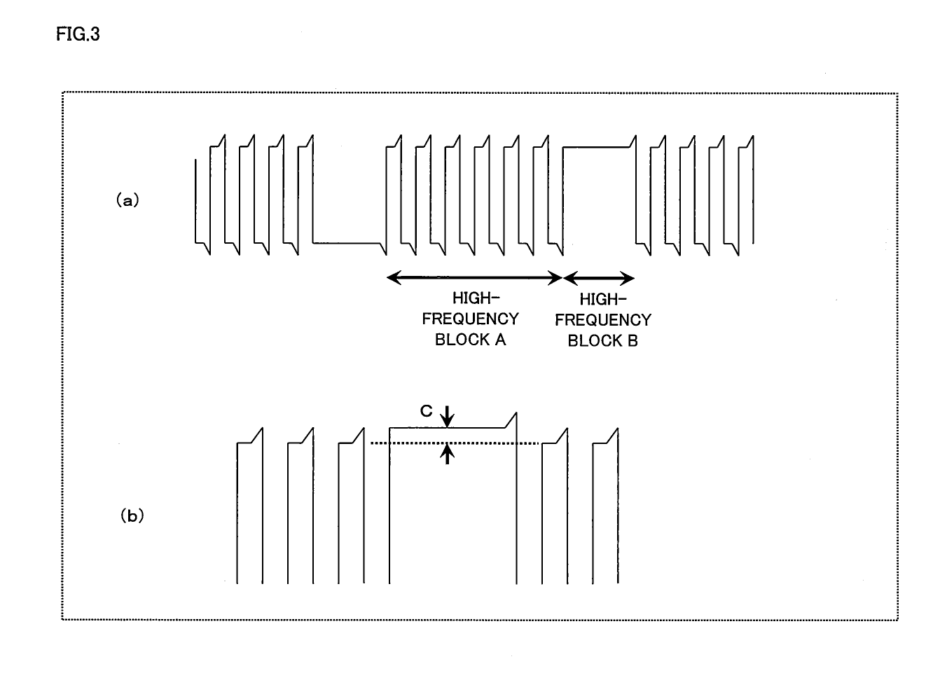

Next, a method for controlling the AC current supplied to the discharge lamp 200 will be described in detail. FIG. 3 is a diagram showing an AC current (1) supplied to the discharge lamp 200. FIG. 3(a) shows an AC current including a high-frequency block A of fundamental frequency, and a low-frequency block B of half-wave.

First, the current detection section Idet detects a current in the high-frequency block A, and a current in the low-frequency block B shown in FIG. 3(a), and the operation section 131 calculates the effective currents in the respective blocks.

Then, in order to make the effective current in the high-frequency block A and the effective current in the low-frequency block B equal to each other, for example, the current in the low-frequency block B is adjusted. As shown in FIG. 3(b), the current value at a flat portion in the low-frequency block B is increased by C.

In this way, an error between the effective current in the high-frequency block A and the effective current in the low-frequency block B is eliminated, whereby luminance variation (flicker) of the discharge lamp 200 is prevented.

In the present embodiment, the current value at a flat portion in the low-frequency block B is increased by C, to eliminate an error between the effective current in the high-frequency block A and the effective current in the low-frequency block B. However, on the contrary, the current value at a flat portion in the low-frequency block A may be decreased by a predetermined value, to eliminate an error between the effective current in the high-frequency block A and the effective current in the low-frequency block B.

Alternatively, the control of increasing the current for a moment just before the polarity inverts may be adjusted, as another method for eliminating an error between the effective current in the high-frequency block A and the effective current in the low-frequency block B.

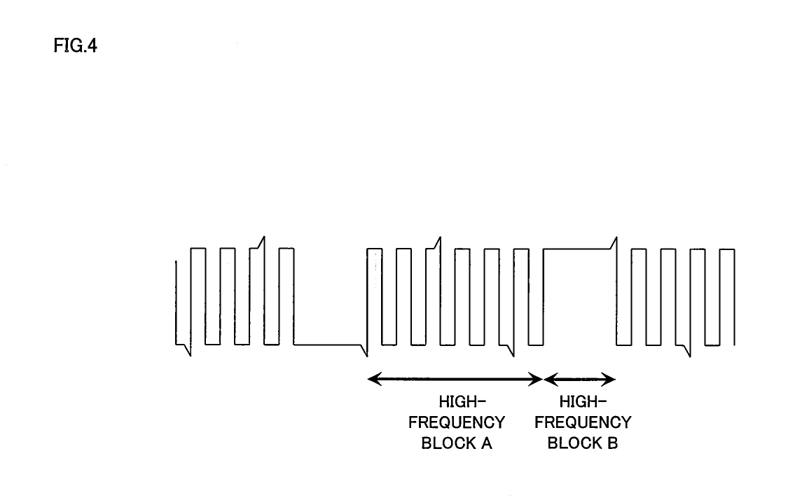

FIG. 4 is a diagram showing an AC current (2) supplied to the discharge lamp 200. As shown in FIG. 4, some of the spikes at which the current is increased for a moment just before the polarity inverts are removed, in comparison with the AC current shown in FIG. 3. In FIG. 3, the current is increased just (for example, 200 to 500 μsec) before all points of the square wave where the polarity inverts. Meanwhile, in FIG. 4, some of the spikes of the square wave in the high-frequency block A at which the current is increased for a moment just before the polarity inverts are removed such that an error between the effective current in the high-frequency block A and the effective current in the low-frequency block B is eliminated.

In this way, an error between the effective current in the high-frequency block A and the effective current in the low-frequency block B is eliminated, whereby luminance variation (flicker) of the discharge lamp 200 is prevented.

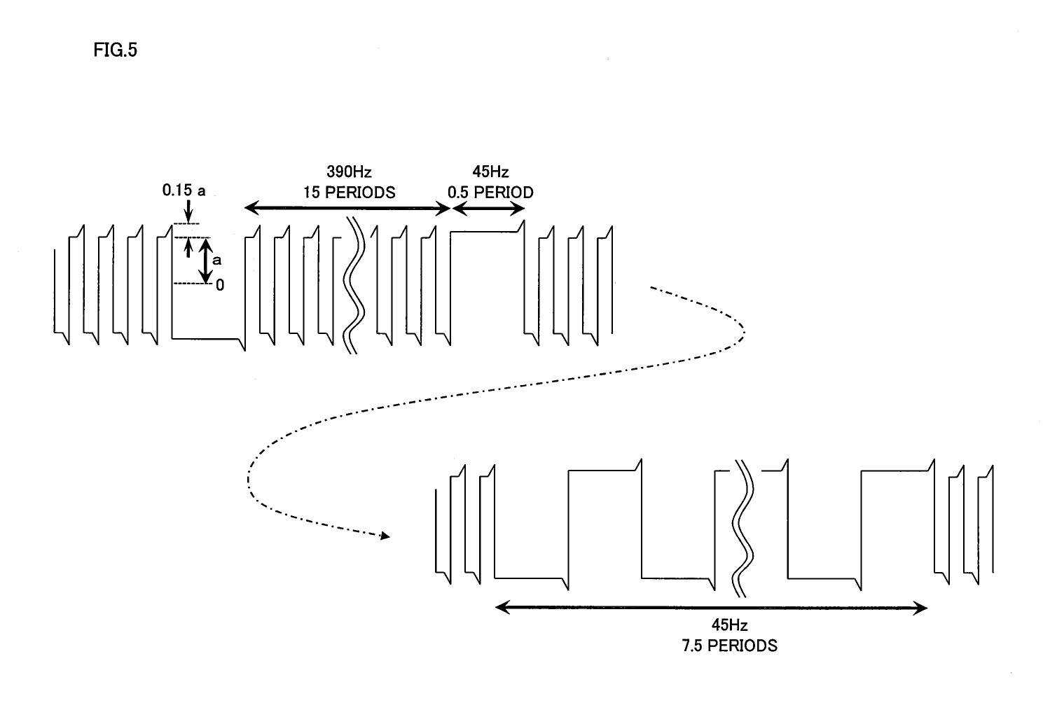

FIG. 5 is a diagram showing a specific example of the case where the effective current in the high-frequency block and the effective current in the low-frequency block are made equal to each other. As shown in FIG. 5, the waveform of the current for driving the discharge lamp 200 includes fifteen periods of square wave having a frequency of 390 Hz in the high-frequency part, and a half period of square wave having a frequency of 45 Hz in the low-frequency part. It is noted that the low-frequency part is inserted every 30 seconds, the inserted low-frequency part having a frequency of 45 Hz and including 7.5 periods of square wave. In addition, the discharge lamp power is 220 W.

In addition, a short-time increased current having a current value of 15% of the current value at a flat portion in the high-frequency part is superimposed just before the polarity inverts, and the effective current is adjusted as described in FIG. 3 and/or FIG. 4, whereby luminance variation (flicker) of the discharge lamp 200 is prevented.

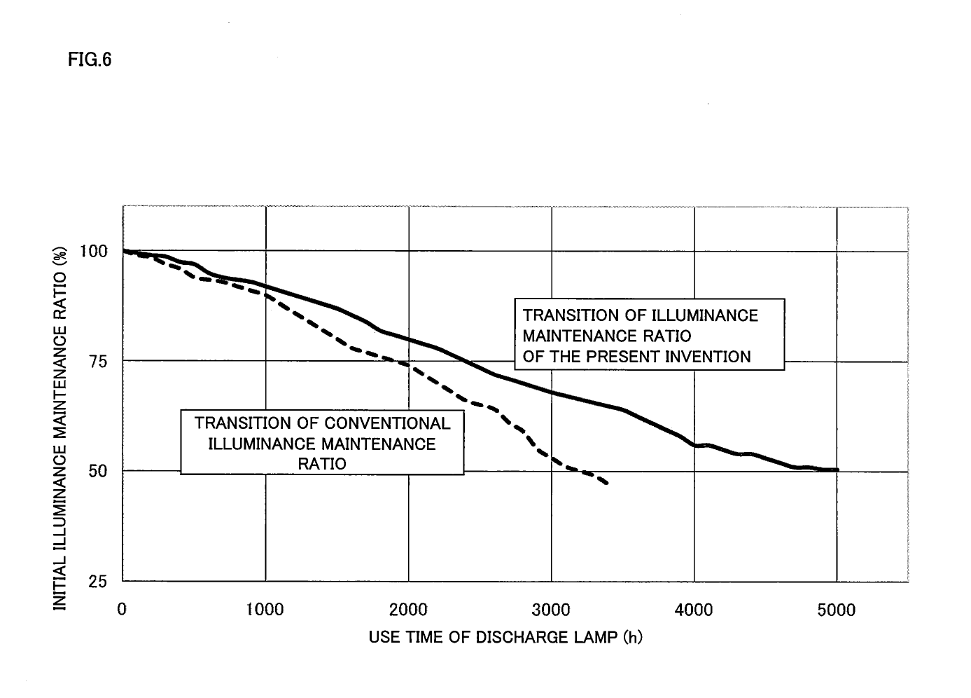

FIG. 6 is a diagram showing a transition of a conventional illuminance maintenance ratio, and a transition of the illuminance maintenance ratio according to the present invention. As shown in FIG. 6, in a conventional drive condition and a conventional specification, the illuminance maintenance ratio becomes about 50% in about 3,000 hours, whereas in the drive condition and the specification shown in FIG. 5 of the present invention, the illuminance maintenance ratio becomes about 50% in about 5,000 hours. Thus, the present invention is effective for increasing the life of discharge lamps.

As described above, the discharge lamp lighting apparatus 100 according to the present embodiment of the present invention can increase the life of the discharge lamp 200 to a sufficiently long period. In addition, the effective current in the high-frequency block and the effective current in the low-frequency block are made equal to each other, whereby luminance variation (flicker) of the discharge lamp 200 is prevented.

As a result, since the life of the discharge lamp 200 used in projectors is increased, users do not need to replace the discharge lamp 200 frequently, and can use projectors for a long period and at ease. In other words, the reliability to users can be improved. At the same time, since luminance variation (flicker) of the discharge lamp 200 is prevented, the more stable discharge lamp 200 which does not cause an uncomfortable phenomenon that is unpleasant to the user's eyes can be provided.

It is noted that discharge lamps keep lighting by arc discharge due to a thermion discharged from a high-temperature electrode. However, a metal of an electrode evaporates by the arc discharge, and the electrode is gradually lost, whereby the electrode for arc discharge disappears, or the distance between electrodes becomes long in the course of the electrodes being lost, whereby the arc discharge becomes impossible. Thus, discharge lamps become unable to light and come to the end of the life.

If the distance between the electrodes becomes long before a discharge lamp comes to the end of the life, since the shape of arc discharge which is a light source varies from a point-light-source-like shape to a long and thin elliptic shape, the efficiency of concentration of light in the light source is deteriorated and the illuminance decreases in accordance with the increase in the distance between the electrodes.

Therefore, in order to reduce loss of electrodes as much as possible, a halogen gas is enclosed inside a discharge lamp, whereby the electrodes are regenerated from the evaporated metal and the life is significantly improved. The mechanism is as follows. First, a metal such as tungsten, which is a material of electrodes, discharges an electron to cause an ion of the metal, and the ion combines with a halogen gas enclosed inside the discharge lamp, whereby a halogen compound is generated. Next, the halogen compound thermally convects to approach a high-temperature portion of an electrode where heat concentrates by arc discharge, and the halogen compound is resolved into the metal and the halogen gas again owing to the high temperature, whereby the electrode is regenerated.

From the above, in view of the life of discharge lamps, it is the most important to maintain the shapes of the electrodes in optimum shapes for arc discharge for a long period. The present invention regenerates the electrodes, thereby maintaining the shapes of the electrodes in optimum shapes for arc discharge.

In other words, the temperature of the electrodes is an important element for regenerating the electrodes. Here, the larger the discharge lamp power supplied to the discharge lamp is, the higher the temperature of the electrodes is. Such an effect is obtained by, in the waveform of the discharge lamp current supplied to the discharge lamp, increasing the current for a moment just before the polarity inverts.

In addition, depending on the drive frequency, the temperature of the electrodes and the areas of the electrodes where heat concentrates vary. Therefore, it is significantly important to set optimum conditions for such elements.

From the above, setting the frequency of the discharge lamp current to an optimum value in accordance with the value of the discharge lamp power, and periodically varying the frequency so as not to be constant, can be an optimum method for increasing the life of discharge lamps. It is important to, in accordance with characteristics and the use state of the discharge lamp, set the varying frequency and appropriately determine an optimum value of the frequency. In addition, similarly to the discharge lamp power, settings of the level and the shape of the current value by which the discharge lamp current supplied to the discharge lamp is increased for a moment just before the polarity inverts, are also important elements.

While the invention has been described in detail, the foregoing description is in all aspects illustrative and not restrictive. It will be understood that numerous other modifications and variations can be devised without departing from the scope of the invention.

What is claimed is:

1. A discharge lamp lighting apparatus for lighting a discharge lamp, the discharge lamp lighting apparatus comprising:
a power supply section for supplying a discharge lamp voltage stipulated in accordance with characteristics of the discharge lamp;
an inverter for inversely converting the discharge lamp voltage supplied by the power supply section into an AC voltage to be applied to the discharge lamp; and
a control section for controlling discharge lamp voltage in the power supply section and drive frequency in the inverter, based on the AC voltage applied to the discharge lamp and AC current flowing in the discharge lamp; wherein:
the control section is configured to control the discharge lamp voltage in the power supply section and the drive frequency in the inverter in such a way that the AC current flowing in the discharge lamp takes on a square-wave form having high-frequency blocks that are high-frequency intervals and low-frequency blocks that are low-frequency intervals, and such that the square-wave form has spikes where the absolute value of the AC current just prior to its polarity inverting is larger than the absolute value of the AC current just after its polarity inverts.

2. The discharge lamp lighting apparatus according to claim 1, wherein the control section is further configured to make the effective current in the high-frequency block and the effective current in the low-frequency blocks equal to each other.

3. The discharge lamp lighting apparatus according to claim 2, wherein the control section is further configured to adjust what the AC current in the high-frequency blocks measures and/or what the AC current in the low-frequency blocks measures.

4. The discharge lamp lighting apparatus according to claim 2, wherein the control section is further configured to adjust the number of the spikes of in the square-wave form.

5. The discharge lamp lighting apparatus according to claim 2, wherein the control section is further configured to adjust the absolute value of the current at the spikes and/or the shapes of the spikes in accordance with characteristics and state of the discharge lamp.

6. The discharge lamp lighting apparatus according to claim 2, wherein the control section is further configured to adjust at least frequency and number of pulses of the AC current in the high-frequency blocks and/or at least frequency and number of pulses of the AC current in the low-frequency blocks in accordance with characteristics and state of the discharge lamp.

7. The discharge lamp lighting apparatus according to claim 2, wherein the control section is further configured to make the AC current have the spikes either in the high-frequency blocks or in the low-frequency blocks.

8. A discharge lamp lighting method executed by a discharge lamp lighting apparatus for lighting a discharge lamp, the discharge lamp lighting method comprising:
a power supply step of supplying a discharge lamp voltage stipulated in accordance with characteristics of the discharge lamp;
an inverse conversion step of inversely converting the discharge lamp voltage supplied in the power supply step into an AC voltage to be applied to the discharge lamp; and
a control step of controlling discharge lamp voltage supplied in the power supply step and drive frequency in the inverse conversion step, based on the AC voltage applied to the discharge lamp and AC current flowing in the discharge lamp; wherein
the control step controls the discharge lamp voltage supplied in the power supply step and the drive frequency in the inverse conversion step in such a way that the AC current flowing in the discharge lamp takes on a square-wave form having high-frequency blocks that are high-frequency intervals, and low-frequency blocks that are low-frequency intervals, and such that the square-wave form has spikes where the absolute value of the AC current just prior to its polarity inverting is larger than the absolute value of the AC current is just after its polarity inverts.
